(19) United States
(12) Patent Application Publication
(10) Pub. No.: US 2015/0178153 A1
(43) Pub. Date: Jun. 25, 2015

(54) MEMORY SYSTEM

(71) Applicant: SK hynix Inc., Gyeonggi-do (KR)

(72) Inventor: Jae Bum KIM, Gyeonggi-do (KR)

(73) Assignee: SK hynix Inc., Gyeonggi-do (KR)

(21) Appl. No.: 14/284,043

(22) Filed: May 21, 2014

(30) Foreign Application Priority Data
Dec. 19, 2013 (KR) 10-2013-0159383

(51) Int. Cl. G06F 11/10

(52) U.S. Cl. CPC G06F 11/1068

(57) ABSTRACT

Provided is a memory system having a memory device. The memory system includes a memory device suitable for performing an even read operation of even memory cells connected to a word line and an odd read operation of odd memory cells connected to the word line, and a controller suitable for performing an error correction operation on even data read out from the even memory cells according to even probability information and odd data read out from the odd memory cells according to odd probability information, and the controller is configured to correct the even probability information or the odd probability information according to characteristics of the even memory cells and the odd memory cells.

### CROSS-REFERENCE TO RELATED APPLICATION

The present application claims priority to Korean patent application number 10-2013-0159383, filed on Dec. 19, 2013, the entire disclosure of which is incorporated herein in its entirety by reference.

### BACKGROUND

1. Field of Invention

The present invention relates to a memory system, and more particularly, to a memory system having a memory device.

2. Description of Related Art

In order to store more information in a limited storage space, a flash memory device stores two or more bits of data in one cell. The more the number of bits of data stored in one cell increases, the more the number of threshold voltage distributions increases and the distance therebetween decreases. Because of this, adjacent threshold voltage distributions can overlap each other.

Because the adjacent threshold voltage distributions overlap, errors can occur in read out data. Thus, an efficient method of detecting and correcting error bits of multi-bit data read out from flash memory devices is required.

### SUMMARY

The present invention is directed to a memory system in which characteristics of a read operation and reliability of read data can be enhanced by controlling a condition related to error correction.

One embodiment of the present invention may have a memory system including a memory device suitable for performing an even read operation of even memory cells connected to a word line and an odd read operation of odd memory cells connected to a word line, and a controller suitable for performing an error correction operation on even data read out from the even memory cells according to even probability information and odd data read out from odd memory cells according to odd probability information, and the controller may be configured to correct the even probability information or the odd probability information according to characteristics of the even memory cells and the odd memory cells.

Another embodiment of the present invention may have a memory system including a memory device suitable for outputting even data from even memory cells of a selected word line and odd data from odd memory cells of a selected word line using read voltages, probability information generation part suitable for generating even probability information using even data and odd probability information using odd data, a probability information correction part suitable for generating corrected even probability information using a correction value (which is determined according to the difference in characteristics of the even memory cells and the odd memory cells and the even probability information and corrected odd probability information using the correction value and the odd probability information), and an error correction part suitable for performing error correction operations on the even data according to the even probability information or the corrected even probability information and the odd data according to the odd probability information or the corrected odd probability information.

Another embodiment of the present invention may provide a memory system including a memory device suitable for reading first and second data from first and second memory cells with first and second groups of read voltages, respectively, and a controller suitable for performing error correction to the read first and second data according to first and second probability information, respectively, wherein the controller modifies one of the first and second probability information based on characteristics of threshold voltage distributions of the first and second memory cells, wherein voltage levels of the first group and the second group are defined independently to each other based on their characteristics, and wherein the first and second probability information are defined independently from each other based on characteristics and the read first and second data.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a block diagram illustrating a memory system according to an embodiment of the present invention;

FIGS. 2 and 3 are circuit diagrams illustrating the memory block shown in FIG. 1;

FIG. 4 is a block diagram illustrating an error correction code (ECC) block shown in FIG. 1;

FIGS. 5 and 6 are flowcharts illustrating an operation of the memory system according to embodiments of the present invention; and

FIGS. 7 and 8 are threshold voltage distributions of memory cells illustrating the operation of the memory system according to an embodiment of the present invention.

### DETAILED DESCRIPTION OF EMBODIMENTS

Hereinafter, exemplary embodiments of the invention will be described with reference to the accompanying drawings. However, since the invention is not limited to the embodiments disclosed, the embodiments of the invention may be implemented in various forms and the scope of the invention is not limited to the exemplary embodiments mentioned below. The embodiments of the invention are only provided for complete disclosure of the invention and to fully show the scope of the invention to those skilled in the art, and it should be understood that the scope of the invention is defined by the scope of the appended claims.

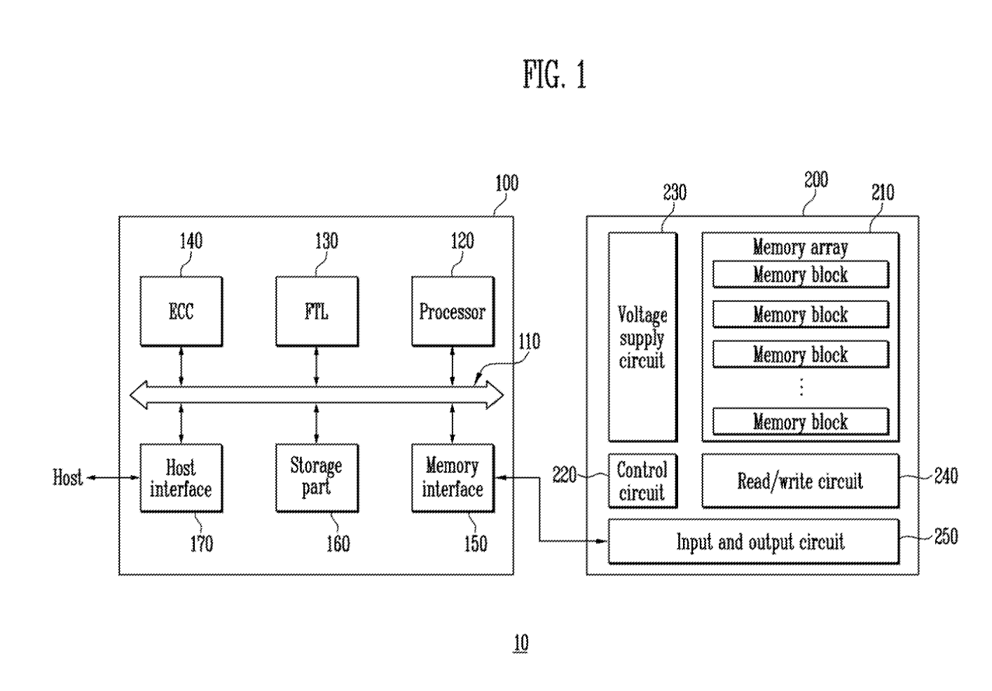

FIG. 1 is a block diagram illustrating a memory system according to an embodiment of the present invention.

Referring to FIG. 1, a memory system 10 may include a memory controller 100 and a memory device 200. The memory controller 100 may be connected to a host HOST and the memory device 200. In response to a request from the host HOST, the memory controller 100 may be configured to access the memory device 200. For example, the memory controller 100 may be configured to control a read operation, a program loop, and an erase loop of the memory device 200. The memory controller 100 may be configured to provide an interface between the memory device 200 and the host HOST. The memory controller 100 may be configured to drive firmware to control the memory device 200. The memory device 200 may include a flash memory device.

The memory controller 100 may include an internal bus 110, a processor 120, a flash translation layer (FTL) 130, an error correction code (ECC) block 140, a memory interface 150, a storage part 160 and a host interface 170. The internal bus 110 may be configured to provide a channel between components of the memory controller 100. For example, the internal bus 110 may be a common channel to transmit a command and data. As another example, the internal bus 110 may include a command channel and a data channel to transmit a command and data, respectively.

The processor 120 may be configured to control the overall operation of the memory controller 100. The processor 120 may be configured to execute software and firmware running on the memory controller 100.

The FTL 130 may provide various means to control the memory device 200. When the memory device 200 is a flash memory device, the flash memory device 200 may have different characteristics than typical memory. First, the flash memory device 200 may have an erase-before-write characteristic. A unit of read operation and program loop of the flash memory device 200 and a unit of erase loop thereof may be different from each other. The read operation and program loop of the flash memory device 200 may be performed in units of pages and the erase loop may be performed in units of memory blocks. The memory block may include a plurality of pages. Further, the number of times the program loop and the erase loop of the flash memory device 200 are repeated may be limited. Erase, program and read times of the flash memory device 200 may be different from one another.

When the host HOST accesses the flash memory device 200, the FTL 130 may provide various control means based on the characteristics of the flash memory device 200 as above described. For example, the FTL 130 may provide a means to convert a logical address received from the host HOST to a physical address of the flash memory device 200. The FTL 130 may keep information for a mapping relationship between the logical address and the physical address in a table. The FTL 130 may provide a means to control the number of programs and the number of erases of the memory blocks of the flash memory device 200 to be uniform. For example, the FTL 130 may provide a means of wear leveling. The FTL 130 may provide a means to minimize the number of erases of the flash memory device 200. For example, the flash memory device 200 may provide a control means such as a merge, garbage collection, and so on.

Particularly, the FTL 130 may provide characteristic information related to interference affecting the even memory cells to the ECC block 140 when a program operation of the odd memory cells is performed. The FTL 130 may provide information related to threshold voltage distribution of the even memory cells and threshold voltage distribution of the odd memory cells to the ECC block 140, In this case, the FTL 130 may be a threshold voltage information providing circuit.

The ECC block 140 may be configured to output corrected even data (using the threshold voltage information of the threshold voltage information providing circuit or the FTL 130 and a plurality of even data read out by read voltages from the even memory cells) and output corrected odd data (using the threshold voltage information and a plurality of odd data read out by read voltages from the odd memory cells).

The memory interface 150 may include a protocol to communicate with the flash memory device 200. For example, the memory interface 150 may include at least one of flash interfaces such as a NAND interface, a NOR interface, and so on

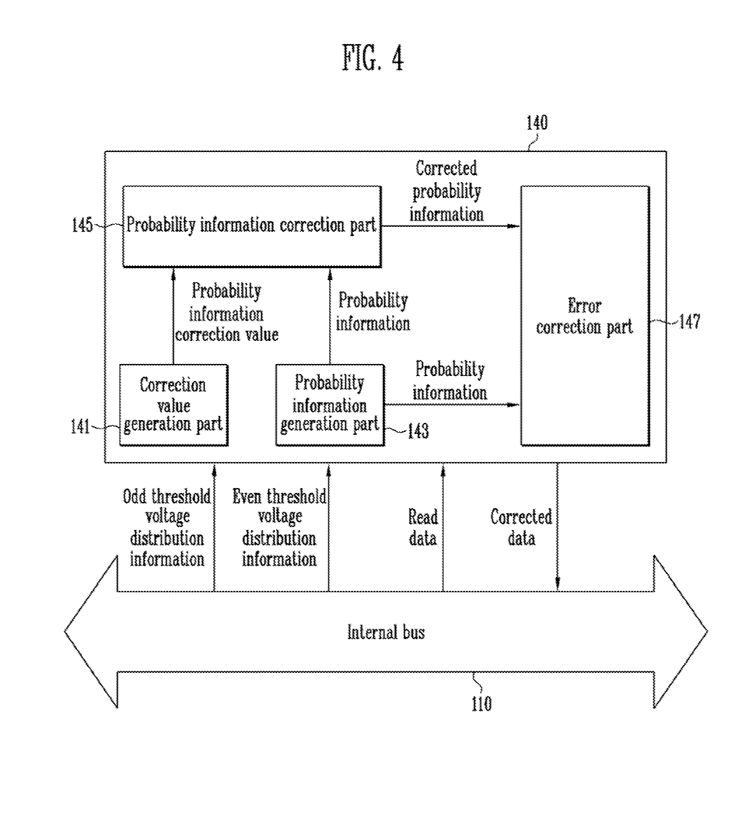

The storage part 160 may be used as operation memory of the processor 120, as a buffer memory between the memory device 200 and the host HOST, and as a cache memory between the memory device 200 and the host HOST. The storage part 160 may also be used as a buffer temporarily storing data received from the memory device 200. When new data is inputted to the storage part 160 after probability information is updated by a probability information generation part 143 (in FIG. 4), the storage part 160 may not store the new data in a new area, but stores the new data in an area in which previous data was stored. Namely, when the new data is inputted after the probability information is updated, the storage part 160 updates the stored data to new data.

For example, the storage part 160 may include at least one of various memories which can be accessed randomly, such as a static random access memory (SRAM), a dynamic random access memory (DRAM), a synchronous DRAM (SDRAM), a phase-change random access memory (PRAM), a magnetic random access memory (MRAM), a resistive random access memory (RRAM), a ferroelectric random access memory (FRAM), a NOR flash memory, and so on

The host interface 170 may include a protocol to exchange data between the host HOST and the memory controller 100. For example, the memory controller 100 may be configured to communicate with the outside (host) through at least one of various interface protocols, such as a Universal Serial Bus (USB) protocol, a MultiMediaCard (MMC) protocol, a Peripheral Component Interconnection (PCI) protocol, a PCI-Express (PCI-E) protocol, an Advanced Technology Attachment (ATA) protocol a Serial-ATA protocol, a Parallel-ATA protocol, a Small Computer System Interface (SCSI) protocol, an Enhanced Small Disk Interface (ESDI) protocol, an Integrated Drive Electronics (IDE) protocol, and so on.

The memory device 200 may include a memory array 210 and operation circuits 220, 230, 240 and 250. Hereinafter, a case in which the memory device 200 is a dash memory device will be described as an example.

The memory array 210 may include a plurality of memory blocks. In the case of a NAND flash memory device, each of the memory blocks may include a plurality of memory strings connected between bit lines and a common source line. Each of the memory strings may include a drain select transistor connected to the bit line, a source select transistor connected to the common source line and a plurality of memory cells connected in series between the drain select transistor and the source select transistor, The memory cells of the memory strings may be connected to word lines. The memory cells connected to the word line configure one physical page. This will be more specifically described below.

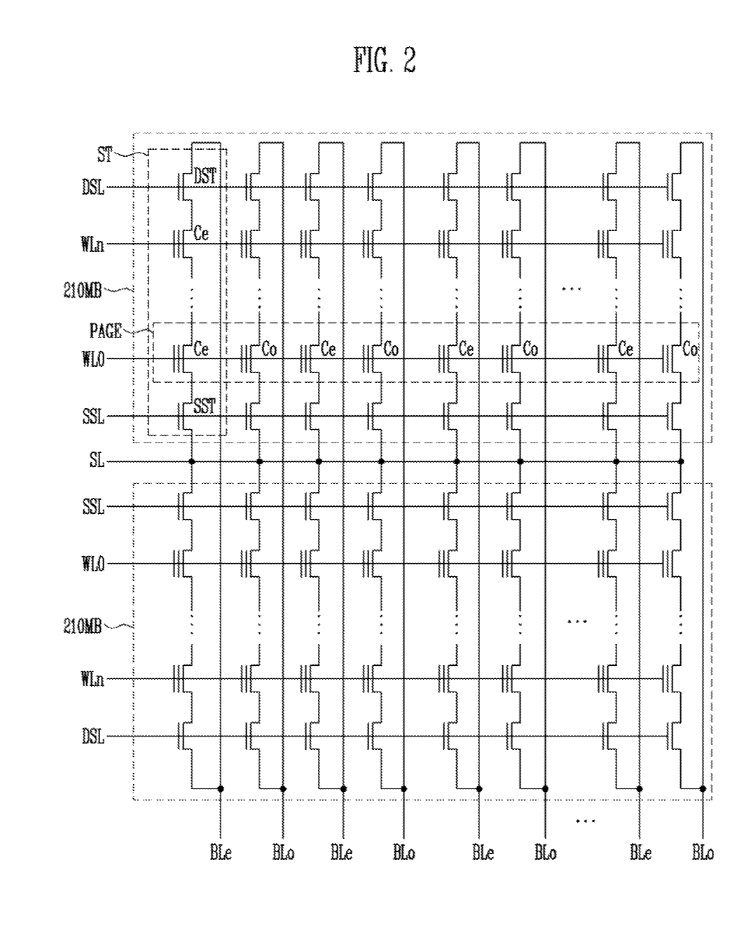

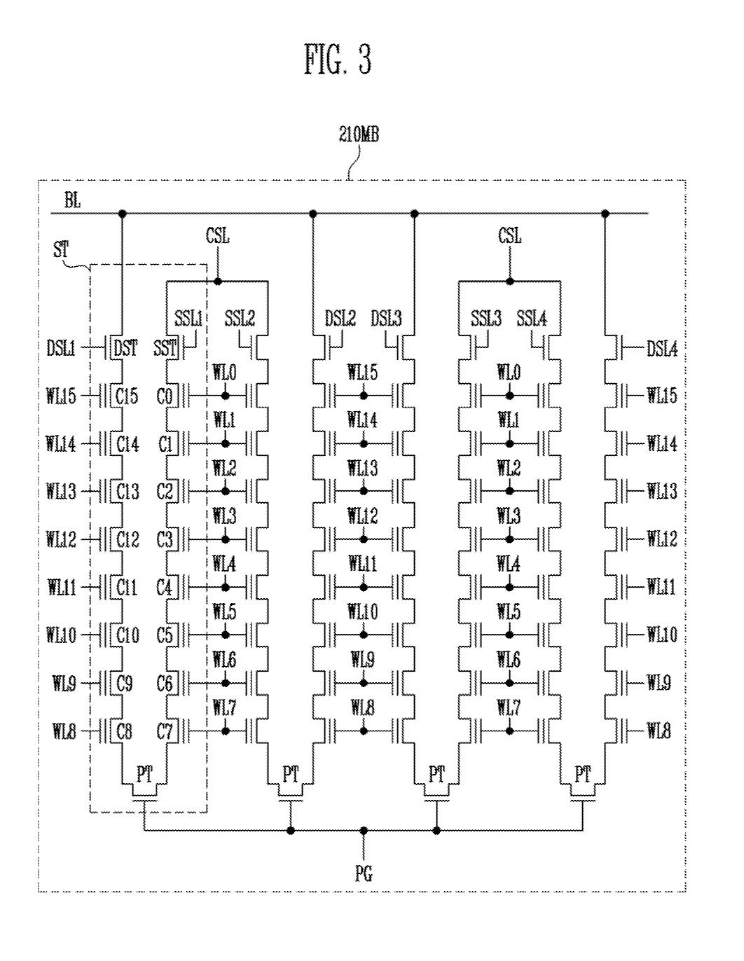

FIGS. 2 and 3 are circuit diagrams illustrating a memory block of the memory device shown in FIG. 1.

Referring to FIG. 2, each memory block may include a plurality of memory strings ST connected between bit lines BLe and BLo and a common source line SL. Namely, the memory strings ST may be connected to the corresponding bit lines BLe and BLo, respectively, and commonly connected to the common source line SL. Each memory string ST may include a source select transistor SST of which a source may be connected to the common source line SL, a cell string of which a plurality of memory cells Ce may be connected in series, and a drain select transistor DST of which a drain may be connected to the bit line BLe. The memory cells Ce included in the cell string may be connected in series between the select transistors SST and DST, A gate of the source select transistor SST may be connected to a source select line SSL, gates of the memory cells Ce may be connected to word lines WL0 to WLn, and a gate of the drain select transistor DST may be connected to a drain select line DSL.

Here, the drain select transistor DST controls a connection or blocking between the cell string Ce and the bit line, and the source select transistor SST controls a connection or blocking between the cell string Ce and the common source line SL.

In a NAND flash memory device, memory cells included in a memory cell block may be classified in units of physical pages or in units of logical pages. For example, memory cells Ce and Co connected to one word line (for example, WL0) configure one physical page. Even-numbered memory cells Ce connected to one word line (for example, WL0) may configure one even physical page, and odd-numbered memory cells Co may configure one odd physical page. The page (or, even page and odd page) may be a basic unit of a program operation or a read operation.

Referring to FIG. 3, in a 3-dimensional memory block, each memory block 210MB may include a plurality of memory strings ST. In a pipe-shaped bit cost scalable (P-BiCS) structure, each memory string ST may include a first memory string SST and C0 to C7 vertically connected between a common source line CSL and a pipe transistor PT of a substrate, and a second memory string C8 to C15 and DST vertically connected between a bit line BL and the pipe transistor PT of the substrate. The first memory string SST and C0 to C7 may include a source select transistor SST and memory cells C0 to C7. The source select transistor SST may be controlled by a voltage applied to a source select line SSL1 and the memory cells C0 to C7 may be controlled by a voltage applied to stacked word lines WL0 to WL7. The, second memory string C8 to C15 and DST may include a drain select transistor DST and memory cells C8 to C15. The drain select transistor DST may be controlled by a voltage applied to a drain select line DSL1, and the memory cells C8 to C15 may be controlled by a voltage applied to stacked word lines WL8 to WL15.

The pipe transistor PT connected between a pair of memory cells C7 and C8 located in the middle of the memory string of the P-BiCS structure may perform an operation for electrically connecting channel layers of the first memory string SST and C0 to C7 and channel layers of the second memory string C8 to C15 and DST, which may be included in the selected memory block 210MB if the memory block 210MB is selected.

Meanwhile, in a memory block of a 2-dimensional (2D) structure, one memory string may be connected to each bit line and drain select transistors of the memory block may be simultaneously controlled by one drain select line. However, in the memory block 210MB of a 3-dimensional (3D) structure, a plurality of memory strings ST may be commonly connected to each bit line. The number of memory strings ST commonly connected to one bit line BL in the same memory block 210MB and controlled by the same word lines may be changed according to design.

As the plurality of memory strings may be connected to one bit line BL in parallel, the drain select transistors DST may be independently controlled by select voltages applied to the drain select lines DSL1 to DSL4 in order to selectively connect one bit line BL and the memory strings ST.

In the memory block 210MB, the memory cells C0 to C7 of the first memory string SST and C0 to C7 and the memory cells C8 to C15 of the second memory string C8 to C15 and DST, which may be vertically connected, may be controlled by operation voltages applied to the stacked word lines WL0 to WL7 and the stacked word lines WL8 to WL15, respectively. The word lines WL0 to WL15 may be classified in units of memory blocks.

Referring back to FIG. 1, the operation circuits 220, 230, 240 and 250 may be configured to perform an erase loop (an erase operation and an erase verify operation), a program loop (a program operation and a program verify operation) and a read operation of the memory block. The operation circuits include a control circuit 220, a voltage supply circuit 230, a read/write circuit 240 and an input and output circuit 250.

The control circuit 220 controls the voltage supply circuit 230, the read/write circuit 240 and the input and output circuit 250 when the erase loop, the program loop and the read operation of the memory cells are performed.

The voltage supply circuit 230 outputs operation voltages needed for the erase loop, the program loop and the read operation to the selected memory block.

The read/write circuit 240 may sense and latch data stored in the memory cells through the bit lines when the read operation or the verify operation is performed, or selectively applies a program prohibition voltage and a program allowable voltage to the bit lines according to data stored in the memory cells when the program operation is performed. The read/write circuit 240 may be implemented as a page buffer.

The input and output circuit 250 may be configured to transmit data received from the memory controller 100 to the read/write circuit 240, or output data read out from the memory cells to the memory controller 100.

The memory device 200 may be configured to output data read out from the memory cells using different levels of read voltages. More specifically, the memory device 200 may be configured to read out data from the memory cells using the different levels of read voltages in order to divide a first threshold voltage distribution and a second threshold voltage distribution which may be adjacent to each other. Namely, the memory device 200 may read out data of the memory cells using the read voltages between the first threshold voltage distribution and the second threshold voltage distribution or the read voltages of an area in which the first threshold voltage distribution and the second threshold voltage distribution overlap. For this, the memory device 200 may read out data from the memory cells using a read voltage sequentially from a lower level to a higher level. Also, the memory device 200 may read out data of the memory cells using a read voltage sequentially from a higher level to a lower level.

As described above, the controller 100 and the memory device 200 may be integrated into one semiconductor device. For example, the controller 100 and the memory device 200 may be integrated into one semiconductor device and may configure a solid state drive (SSD). The controller 100 and a non-volatile memory device 200 may be integrated into one semiconductor device and may configure a memory card. For example, the controller 100 a id the non-volatile memory device 200 may be integrated into one semiconductor device and may configure a memory card such as a personal computer (PC) card (Personal Computer Memory Card International Association (PCMCIA)), a Compact Flash (CF) card, a SmartMedia (SM) card (SMC), a Memory Stick, an MMC (reduced Size MMC (RS-MMC), MMCmicro), a Secure Digital (SD) card (miniSD, microSD, SD High Capacity (SDHC)), a Universal Flash Storage (UFS), and so on.

The controller 100 and the memory device 200 may be integrated into one semiconductor device and may configure the SSD. The SSD may include a storage device configured to store data in a semiconductor memory. When the semiconductor device 10 is used as the SSD, an operation speed of the host HOST connected to the semiconductor device 10 may be innovatively enhanced.

As another example, the semiconductor device 10 may configure a computer, an ultra mobile PC (UMPC), a workstation, a net-book, a personal digital assistant (PDA), a portable computer, a web tablet, a tablet computer, a wireless phone, a mobile phone, a smartphone, an e-book, a portable multimedia player (PMP) a portable game console, a navigation device, a black box, a digital camera, a digital multimedia broadcasting (DMB) player, a 3-dimensional television, a smart television, a digital audio recorder, a digital audio player, a digital picture recorder, a digital picture player, a digital video recorder, a digital video player, a storage configuring data center, a device for wirelessly sending and receiving information, at least one of various electronic devices configuring a home network, at least one of various electronic devices configuring a computer network, at least one of various electronic devices configuring a telematics network, an RID device at least one of various components configuring a computing system etc.

Hereinafter, the ECC block 140 shown in FIG. 1 will be described in detail. FIG. 4 is a block diagram illustrating the ECC block 140 shown in FIG. 1.

Referring to FIG. 4, the ECC block 140 may include probability information providing parts 141, 143 and 145 and an error correction part 147. The probability information providing parts 141, 143 and 145 may be configured to generate probability information or corrected probability information using threshold voltage information of even and and odd memory cells, which may be provided by the FTL 130, and the plurality of even and odd data respectively read out by read voltages from the even and odd memory cells.

For example, the probability information providing parts 141, 143 and 145 may generate even probability information or corrected even probability information using the threshold voltage information and the plurality of even data. In addition, the probability information providing parts 141, 143 and 145 may generate odd probability information or corrected odd probability information using the threshold voltage information and the plurality of odd data. The probability information providing parts 141, 143 and 145 may be configured to correct the odd probability information without correcting the even probability information, and vise versa.

The probability information providing parts 141, 143 and 145 may include a correction value generation part 141, a probability information generation part 143 and a probability information correction part 145.

The correction value generation part 141 may be configured to generate a correction value based on the threshold voltage information. As an example, the correction value may be calculated as the following Equation 1 or Equation 2.

Probability information correction value (R)=value of threshold voltage distribution of even memory cells (σ²ₑᵥₑₙ)/value of threshold voltage distribution of odd memory cells (σ²_{odd}) [Equation 1]

Probability information correction value R=value of threshold voltage distribution of odd memory cells (σ²_{odd}) value of threshold voltage distribution of even memory cells (σ² ₑᵥₑₙ) [Equation 2]

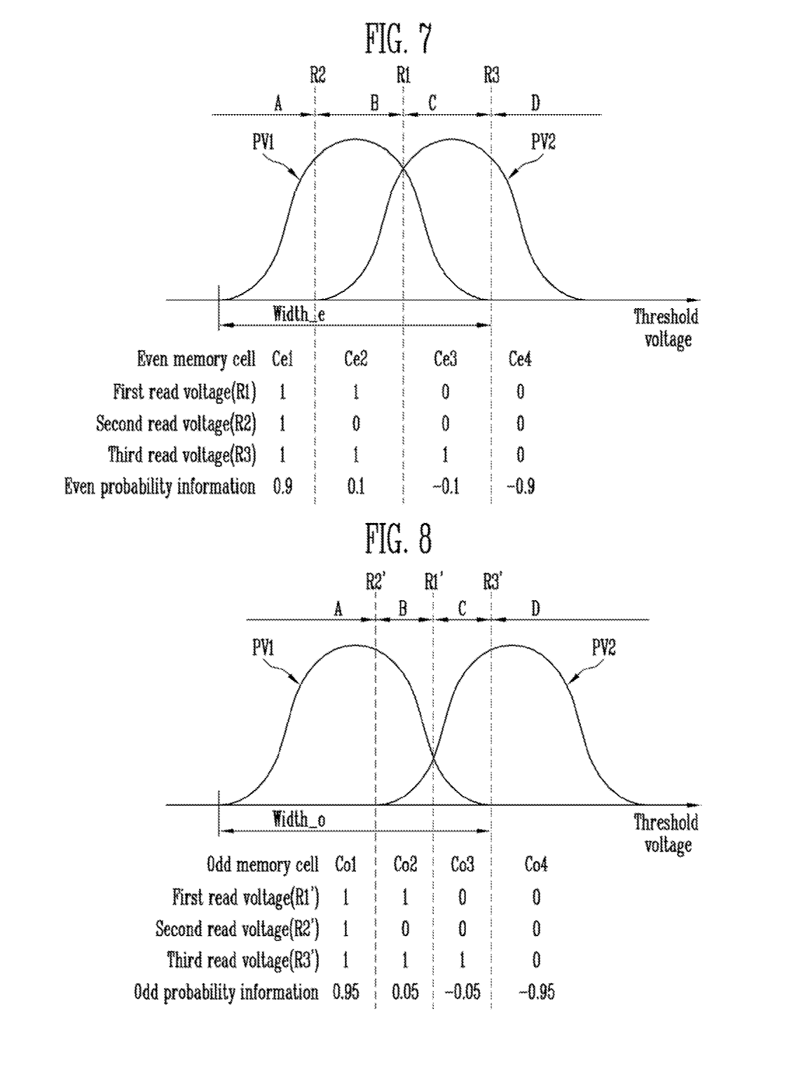

In above Equations 1 and 2, the values of threshold voltage distribution of even and odd memory cells may represent widths (Width_e and Width_o shown in FIGS. 7 and 8) of threshold voltage distribution of even and odd memory cells, respectively.

The probability information generation part 143 may be configured to generate the even probability information using the plurality of even data, and generate the odd probability information using the plurality of odd data. The probability information generation part 143 may output the even probability information to the probability information correction part 145 and output the odd probability information to the error correction part 147 when the even probability information is corrected, Also, the probability information generation part 143 may output the even probability information to the error correction part 147 and output the odd probability information to the probability information correction part 145 when the odd probability information is corrected, This will be described in detail below.

The probability information correction part 145 may be configured to generate the corrected even probability information using the correction value of the correction value generation part 141 and the even probability information of the probability information generation part 143, and generate the corrected odd probability information using the correction value and the odd probability information. The corrected even probability information or the corrected odd probability information may be outputted to the error correction part 147,

The error correction part 147 may be configured to perform an error correction operation according to the even probability information or the corrected even probability information and output corrected even data, and perform an error correction operation according to the odd probability information or the corrected odd probability information and output corrected odd data.

The odd threshold voltage distribution information, the even threshold voltage distribution information, the plurality of read data and the corrected data may be transmitted through the internal bus 110.

Hereinafter, an operation of a memory system having the above configuration will be described.

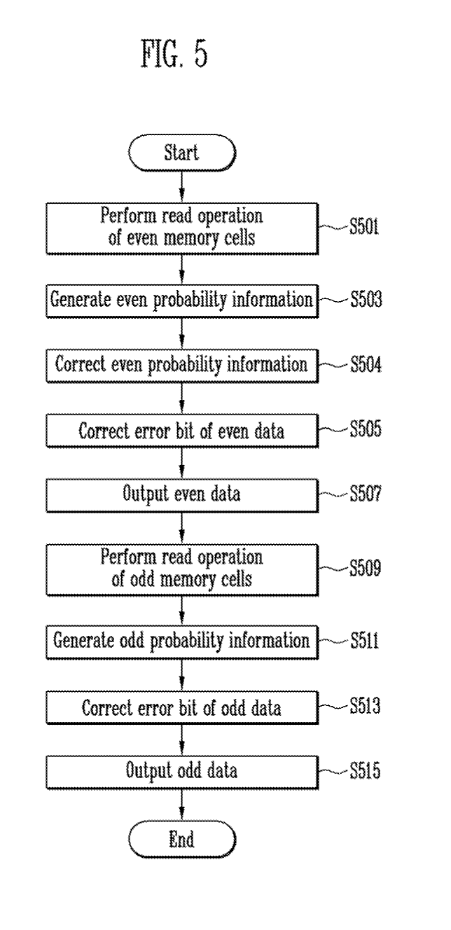

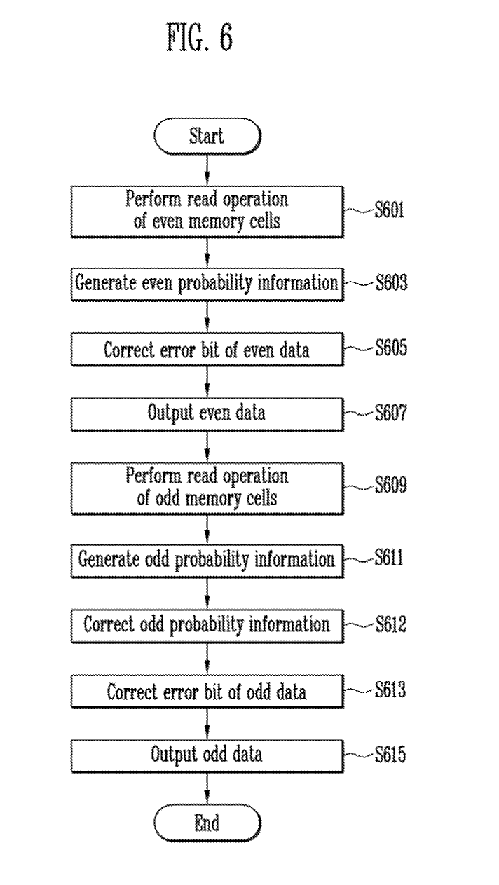

FIGS. 5 and 6 are flowcharts illustrating an operation of the memory system 10 according to embodiments of the present invention. FIGS. 7 and 8 are threshold voltage distributions of memory cells illustrating the operation of the memory system 10 according to an embodiment of the present invention.

Referring to FIGS. 5 and 7, in the step of S501 a read operation of even memory cells may be performed. For example, a first read operation of applying a first read voltage R1 to even memory cells Ce1, Ce2, Ce3 and Ce4 of a selected word line may be performed. The threshold voltages of the even memory cells Ce1 and Ce2 may be lower than the first read voltage R1, and the threshold voltages of the even memory cells Ce3 and Ce4 may be higher than the first read voltage R1. Therefore, first data having a value ‘1100’ may be read out from the even memory cells Cel, Ce2, Ce3 and Ce4 in the first read operation, and the read out first data may be outputted from the memory device 200 to the controller 100. The first data may be stored in the storage part 160 of the controller 100. Then, a second read operation may be performed using a second read voltage R2, which may be higher than the threshold voltages of the even memory cell Cel and lower than the even memory cells Ce2, Ce3 and Ce4. Second data having a value ‘1000’ may be read out from the even memory cells Ce1, Ce2, Ce3 and Ce4 in the second read operation, and the read out second data may be outputted from the memory device 200 to the controller 100. Likewise, third data having a value ‘1110’ may be read out from the even memory cells Ce1, Ce2, Ce3 and Ce4 in a third read operation using a third read voltage R3, which may be higher than the threshold voltages of the even memory cells Cel, Ce2 and Ce3 and lower than the even memory cell Ce4, and the read out third data may be output from the memory device to the controller.

Thereby, a plurality of data for generating the probability information may be stored in the storage part 160 of the controller 100. The case in which three data are used has been described above as an example, However, the number of data needed to generate the probability information may be varied according to accuracy of error correction or time assigned to error correction.

In step S503, the even probability information may be generated by the probability information generation part 143. As an example, the probability information generation part 143 of the ECC block 140 may generate the even probability information using the plurality of even data read out by read voltages R1, R2 and R3 from the even memory cells Ce1, Ce2, Ce3 and Ce4. By the first to third read operations, the even memory cell Cel may be determined to have a low threshold voltage and a high possibility of belonging to a first threshold voltage distribution PV1, and the even memory cell Ce4 may be determined to have a high threshold voltage and a high possibility of belonging to a second threshold voltage distribution PV2. The threshold distribution, to which other even memory cells Ce2 and Ce3 belong, may be uncertain. Therefore, absolute values of the probability information of the even memory cells Ce1 and Ce4 may be relatively large, while the absolute values of the probability information of the even memory cells Ce2 and Ce3 may be relatively small,

In step S504, the even probability information correction may be performed by the probability information correction part 145. For this the correction value generation part 141 may output the correction value of the probability information generated according to Equations 1 and 2 to the probability information correction part 145, and the probability information generation part 143 may output the even probability information, which is generated in step S503, to the probability information correction part 145. The probability information correction part 145 may generate the corrected even probability information according to the following Equation 3. The corrected even probability information may be output to the error correction part 147.

corrected even probability information (LLRₑᵥₑₙ′)=even probability information (LLRₑᵥₑₙ)×probability information correction value (R) [Equation 3]

In the step of S505, an error bit correction operation for the even data may be performed by the error correction part 147. The error correction part 147 may perform the error correction operation using the corrected even probability information, which is generated by the probability information correction part 145 in step S504. As an example, the error correction part 147 may perform the error correction operation using the corrected even probability information and may change the corrected even probability information using a low-density parity-check (LDPC) code when the error correction operation with the corrected even probability information fails. Then, the error correction part 147 may perform the error correction operation again using the corrected and further changed even probability information. Changing the corrected even probability information with the LDPC code and performing the error correction operation with the corrected and changed even probability information may be performed repeatedly within the scope allowed until the error correction operation succedes.

In step S507, when the error correction operation of the error correction part 147 succedes, the corrected even data may be outputted. The corrected even data may be outputted from the controller 100 to the host.

Referring to FIGS. 5 and 8, in step S509, a read operation of odd memory cells may be performed. For example, a first read operation applying a first read voltage R1′ to odd memory cells Co1, Co2, Co3 and Co4 of a selected word line may be performed. The threshold voltages of the odd memory cells Co1 and Co2 may be lower than the first read voltages R1¹ and the threshold voltages of the odd memory cells Co3 and Co4 may be higher than the first read voltage R1¹. Therefore, first data having a value ‘1100’ may be read out from the odd memory cells Co1, Co2, Co3 and Co4 in the first read operation and the read out first data may be outputted from the memory device 200 to the controller 100. The first data may be stored in the storage part 160 of the controller 100. Then, a second read operation may be performed using a second read voltage R2′, which may be higher than the threshold voltages of the odd memory cell Co1 and lower than the odd memory cells Co2, Co3 and Co4. Second, data having a value ‘1000’ may be read out from the odd memory cells Co1, Co2, Co3 and Co4 in the second read operation, and the read out second data may be output from the memory device 200 to the controller 100. Likewise, third data having a value ‘1110’ may be read out from the odd memory cells Co1, Co2, Co3 and Co4 in the third read operation using a third read voltage R3′, which may be higher than the threshold voltages of the odd memory cells Co1, Co2 and Co3 and lower than the odd memory cell Co4, and the read out third data may be output from the memory device 200 to the controller 100. Hereby, a plurality of data for generating probability information may be stored in the storage part 160 of the controller 100.

The threshold voltages of the even memory cells may be changed by interference occurring when the program operation of the odd memory cells is performed. Because interference characteristics of the even memory cells and the odd memory cells may be different from each other, distribution characteristics of the threshold voltage may be different from each other. For this reason, the read voltages R1′, R2′ and R3′ for the read out of the odd memory cell in step S509 may be different from the read voltages R1, R2 and R3 for the read out of the even memory cells in step S501. When the same read voltages are used, a generation condition of the odd probability information in step S511 may be set differently from that of the even probability information in step S503. When the same generation conditions of the probability information is also set, in step S504, the correction of even probability information may be modified by giving consideration to the difference in distribution characteristics of the threshold voltage to the probability information correction value (R) represented by Equations 1 and 2.

In step S511, the odd probability information may be generated by the probability information generation part 143. As an example, the probability information generation part 143 of the ECC block 140 may generate the odd probability information using the plurality of odd data read out by read voltages R1′, R2′ and R3′ from the odd memory cells Co1, Co2, Co3 and Co4. By first to third read operations, the odd memory cell Co1 may be determined to have a low threshold voltage and a high possibility of belonging to the first threshold voltage distribution PV1 and the odd memory cell Co4 may be determined to have a high threshold voltage and a high possibility of belonging to the second threshold voltage distribution PV2. The threshold distribution, to which other odd memory cells Co2 and Co3 belong may be uncertain. Therefore, absolute values of the probability information of the odd memory cells Co1 and Co4 may be relatively large, while absolute values of the probability information of the odd memory cells Co2 and Co3 may be relatively small. Interference to the odd memory cells occurring when the program operation of the even memory cells is performed has little effect on the threshold voltages of the odd memory cells, and therefore the difference between the large and small absolute values of the odd probability information may be greater than that of the even probability information.

In step S513, the error bit correction operation for the odd data may be performed by error correction part 147. The error correction part 147 may perform the error correction operation using the odd probability information, which is generated by the probability information generation part 143 in step S511. As an example, the error correction part 147 may perform an error correction operation using the odd probability information and may change the odd probability information using the LDPC code when the error correction operation with the odd probability information fails. Then, the error correction part 147 may perform the error correction operation again using the changed odd probability information. Changing the odd probability information with the LDPC code and performing the error correction operation with the changed odd probability information may be performed repeatedly within the scope allowed until the error correction operation succeeds.

In step S515, when the error correction operation of the error correction part 147 succeeds, the corrected odd data may be outputted. The corrected odd data may be outputted from the controller 100 to the host.

The case in which the even probability information is corrected and the error correction is performed using the corrected even probability information has been described above as an example. However, the odd probability information may be corrected and the error correction may be performed using the corrected odd probability information, This will be more specifically described below.

Referring to FIGS. 6 and 7, steps S601 and S603 may be performed in the same manner as steps S501 and S503 in FIG. 5.

In step S605, an error bit correction operation for the even data may be performed by the error correction part 147, The error correction part 147 may perform the error correction operation using even probability information, which is generated by the probability information generation part 143. Unlike step S505 in FIG. 5, in step S605 the error correction operation may be performed using the even probability information. The error correction operation of step S605 may be performed in the same manner as step S505 except for the corrected even probability information.

Steps S607, S609 and S611 may be performed in the same manner as steps S507, S509 and S511 in FIG. 5.

In step S612, the odd probability information correction may be performed by the probability information correction part 145, For this, the correction value generation part 141 may output the correction value of the probability information generated according to Equations 1 and 2 to the probability information correction part 145, a id the probability information generation part 143 may output the odd probability information, which is generated in step S611, to the probability information correction part 145. The probability information correction part 145 may generate the corrected odd probability information according to the following Equation 4. The corrected even probability information may be outputted to the error correction part 147.

corrected odd probability information (LLR_{odd}′) odd probability information (LLR_{odd})×probability information correction value (R) [Equation 4]

In step S613, an error bit correction operation for the odd data may be performed by the error correction part 147. The error correction part 147 may perform the error correction operation using the corrected odd probability information, which is generated by the probability information correction part 145 in step S612. As an example, the error correction part 147 may perform the error correction operation using the corrected odd probability information, and may change the corrected odd probability information using the LDPC code when the error correction operation with the corrected odd probability information fails. Then, the error correction part 147 may perform the error correction operation again using the corrected and further changed odd probability information, Changing the corrected odd probability information with the LDPC code and performing the error correction operation with the corrected and changed odd probability information may be performed repeatedly within the scope allowed until the error correction operation succeeds.

In step S615, when the error correction operation of the error correction part 147 succeeds, the corrected odd data may be outputted.

The corrected odd data may be outputted from the controller 100 to the host.

As described above, as the even probability information or the odd probability information may be corrected and the error correction operation may be performed according to the corrected probability information by reflecting the interference affecting the even memory cells and the characteristics difference between the threshold voltage distributions of the even memory cells and the odd memory cells when the program operation of the even or odd memory cells is performed, performance of the error correction and reliability of output data may be enhanced.

An embodiment of the present invention can enhance characteristics of a read operation and reliability of read data by controlling conditions related to error correction.

In the drawings and specification, there have been disclosed typical exemplary embodiments of the invention and, although specific terms are employed, they are used in a generic and descriptive sense only and not for the purpose of limiting the scope of the invention. As for the scope of the invention, it is to be set forth in the following claims.

Therefore, it will be understood by those of ordinary skill in the art that various changes in form and details may be made therein without departing from the spirit and scope of the present invention as defined by the following claims.

What is claimed is:

1. A memory system, comprising:
a memory device suitable for performing an even read operation of even memory cells connected to a word line and an odd read operation of odd memory cells connected to the word line; and
a controller suitable for performing an error correction operation on even data read out from the even memory cells according to even probability information and an error correction operation on odd data read out from the odd memory cells according to odd probability information, wherein the controller is configured to correct the even probability information or the odd probability information according to characteristics of the even memory cells and the odd memory cells.

2. The memory system of claim 1, wherein the controller is configured to correct the even probability information or the odd probability information based on interference affecting the even memory cells when a program operation of the odd memory cells is performed.

3. The memory system of claim 1, wherein the controller is configured to correct the even probability information or the odd probability information based on a difference between a threshold voltage distribution of the even memory cells and a threshold voltage distribution of the odd memory cells.

4. The memory system of claim 1, wherein the controller comprises:
a threshold voltage information providing circuit suitable for providing threshold voltage information of the threshold voltage distributions of the even memory cells and the odd memory cells; and
an error correction code (ECC) block suitable for performing the error correction operation on the even and odd data using the threshold voltage information.

5. The memory system of claim 4, wherein the ECC block comprises:
a probability information providing part suitable for generating the even probability information or corrected even probability information using the threshold voltage information and the even data, and the odd probability information or corrected odd probability information using the threshold voltage information and the odd data; and
an error correction part suitable for performing the error correction operation on the even data according to the even probability information or the corrected even probability information, and the odd data according to the odd probability information or the corrected odd probability information.

6. The memory system of claim wherein the probability information providing part comprises:
a correction value generation part suitable for generating correction value based on the threshold voltage information;
a probability information generation part suitable for generating the even probability information using the even data, and the odd probability information using the odd data; and
a probability information correction part suitable for generating the corrected even probability information using the correction value and the even probability information, and the corrected odd probability information using the correction value and the odd probability information.

7. The memory system of claim 6, wherein the probability information generation part is configured to output the odd probability information to the error correction part when the even probability information is corrected, and to output the even probability information to the error correction part when the odd probability information is corrected.

8. The memory system of claim 4, wherein the threshold voltage information providing circuit comprises a flash translation layer.

9. The memory system of claim 1, wherein the memory device is configured to output the even data read out from the even memory cells using even read voltages to identify first and second threshold voltages of the even memory cells to the controller when the even read operation is performed, and output the odd data read out from the odd memory cells using odd read voltages to identify the first and second threshold voltages of the odd memory cells to the controller when the odd read operation is performed.

10. The memory system of claim 9, wherein the even read voltages and the odd read voltages are different from each other.

11. A memory system, comprising:
a memory device suitable for outputting even data from even memory cells of a selected word line and odd data from odd memory cells of the selected word line using read voltages;
a probability information generation part suitable for generating even probability information using the even data, and odd probability information using the odd data;
a probability information correction part suitable for generating corrected even probability information using a correction value, which is determined according to a difference in characteristics between the even memory cells and the odd memory cells, and the even probability information, and corrected odd probability information using the correction value and the odd probability information; and
an error correction part suitable for performing error correction operations on the even data according to the even probability information or the corrected even probability information, and the odd data according to the odd probability information or the corrected odd probability information.

12. The memory system of claim 11, further comprising
a correction value generation part suitable for generating the correction value based on interference affecting the even memory cells when a program operation of the odd memory cells is performed.

13. The memory system of claim 11, further comprising
a correction value generation part suitable for generating the correction value according to threshold voltage information of threshold voltage distributions of the even memory cells and the odd memory cells.

14. The memory system of claim 13 further comprising
a flash translation layer suitable for providing the threshold voltage information.

15. The memory system of claim 11, wherein the error correction part is configured to output the corrected even data and the corrected odd data using the even probability information and the corrected odd probability information.

16. The memory system of claim 11, wherein the error correction part is configured to output the corrected even data and the corrected odd data using the corrected even probability information and the corrected odd probability information.

17. A memory system, comprising
a memory device suitable for reading first and second data from first and second memory cells with first and second groups of read voltages, respectively; and
a controller suitable for performing error correction to the first and second data according to first and second probability information, respectively,
wherein the controller modifies one of the first and second probability information based on characteristics of threshold voltage distributions of the first and second memory cells,
wherein voltage levels of the first group and the second group are defined independently to each other based on the characteristics, and
wherein the first and second probability information are defined independently from each other based on the characteristics and the read first and second data

18. The memory system of claim 17, wherein the characteristics are widths of the threshold voltage distributions of the first and second memory cells.

19. The memory system of claim 17, wherein interval of voltage levels of the first group is greater than interval of voltage levels of the second group.

20. The memory system of claim 17, wherein the first and second probability information include a possibility that the first and second memory cells belong to a specific level in the threshold voltage distributions of the first and second memory cells, respectively, and
wherein the probability included in the second probability information is higher than the probability included in the first probability information.
